(19) United States
(12) Patent Application Publication
(10) Pub. No.: US 2024/0370903 A1
(43) Pub. Date: Nov. 7, 2024

(54) CONTINUOUS AD PROXY

(71) Applicant: Atmosphere.tv, Austin, TX (US)

(72) Inventors: Jeff DiTullio, Austin, TX (US); Brent Hays, Austin, TX (US); Michael Santa Cruz, Eagle, ID (US); Cody Howard, Austin, TX (US)

(21) Appl. No.: 18/311,760

(22) Filed: May 3, 2023

(51) Int. Cl. G06Q 30/0272

(52) U.S. Cl. CPC G06Q 30/0272

(57) ABSTRACT

Systems and methods are disclosed for implementing a continuous ad proxy. In certain embodiments, a method may comprise performing an ad proxy service at an ad proxy server, including receiving a content playing indicator from a client device indicating that the client device is playing content, and in response to the content playing indicator, negotiating a plurality of advertisements with an ad server by obtaining ad metadata to fill an ad queue of the ad proxy service. The method may further comprise receiving an ad break indicator from the client device, providing the client with first ad metadata corresponding to a subset of the plurality of advertisements selected from the ad queue to fill the ad break, and automatically refilling the ad queue as advertisements are consumed.

### SUMMARY

In certain embodiments, a method may comprise performing an ad proxy service at an ad proxy server, including receiving a content playing indicator from a client device indicating that the client device is playing content, and in response to the content playing indicator, negotiating a plurality of advertisements with an ad server by obtaining ad metadata to fill an ad queue of the ad proxy service. The method may further comprise receiving an ad break indicator from the client device, providing the client device with first ad metadata corresponding to a subset of the plurality of advertisements selected from the ad queue to fill the ad break, and automatically refilling the ad queue as advertisements are consumed.

In certain embodiments, a system may comprise an ad proxy server configured to perform an ad proxy service, including receive a stream start indicator from a client device indicating that the client device has begun playing a content stream, and in response to the stream start indicator, negotiate a plurality of advertisements with an ad server by obtaining ad metadata to fill an ad queue of the ad proxy service. The system may provide the client device with first ad metadata corresponding to a subset of the plurality of advertisements selected from the ad queue to fill an ad break of the client device, and automatically refill the ad queue as advertisements are consumed.

In certain embodiments, a memory device may store instructions that, when executed, cause a processor to perform a method comprising obtaining, at a client device from an ad proxy service, advertisements for display during ad breaks in content playing at the client device, including sending a content playing indicator to the ad proxy service indicating that the client device has begun playing content, and prior to each ad break, sending a fetch request to the ad proxy service directing the ad proxy service to provide ad metadata corresponding to an advertisement for the upcoming ad break to the client device. The instructions may further cause the processor to perform a method comprising obtaining the advertisement from an ad server based on the ad metadata, and displaying the advertisement during the upcoming ad break.

### BRIEF DESCRIPTION OF THE DRAWINGS

FIG. 1 is a diagram of a system configured to implement a continuous ad proxy, in accordance with certain embodiments of the present disclosure;

FIGS. 2A and 2B are diagrams of systems configured to implement a continuous ad proxy, in accordance with certain embodiments of the present disclosure;

FIG. 3 is a process flow diagram of a system configured to implement a continuous ad proxy, in accordance with certain embodiments of the present disclosure;

FIG. 4 is a flowchart of an example method for implementing a continuous ad proxy, in accordance with certain embodiments of the present disclosure;

FIG. 5 is a flowchart of an example method for implementing a continuous ad proxy, in accordance with certain embodiments of the present disclosure; and

FIG. 6 is a diagram of a system configured to implement a continuous ad proxy, in accordance with certain embodiments of the present disclosure.

### DETAILED DESCRIPTION

In the following detailed description of certain embodiments, reference is made to the accompanying drawings which form a part hereof, and in which are shown by way of illustration of example embodiments. It is also to be understood that features of the embodiments and examples herein can be combined, exchanged, or removed, other embodiments may be utilized or created, and structural changes may be made without departing from the scope of the present disclosure.

In accordance with various embodiments, the methods and functions described herein may be implemented as one or more software programs running on a computer processor or controller. Dedicated hardware implementations including, but not limited to, application specific integrated circuits, programmable logic arrays, and other hardware devices can likewise be constructed to implement the methods and functions described herein. Methods and functions may be performed by modules or nodes, which may include one or more physical components of a computing device (e.g., logic, circuits, processors, etc.) configured to perform a particular task or job, or may include instructions that, when executed, can cause a processor to perform a particular task or job, or any combination thereof. Further, the methods described herein may be implemented as a computer readable storage medium or memory device including instructions that, when executed, cause a processor to perform the methods.

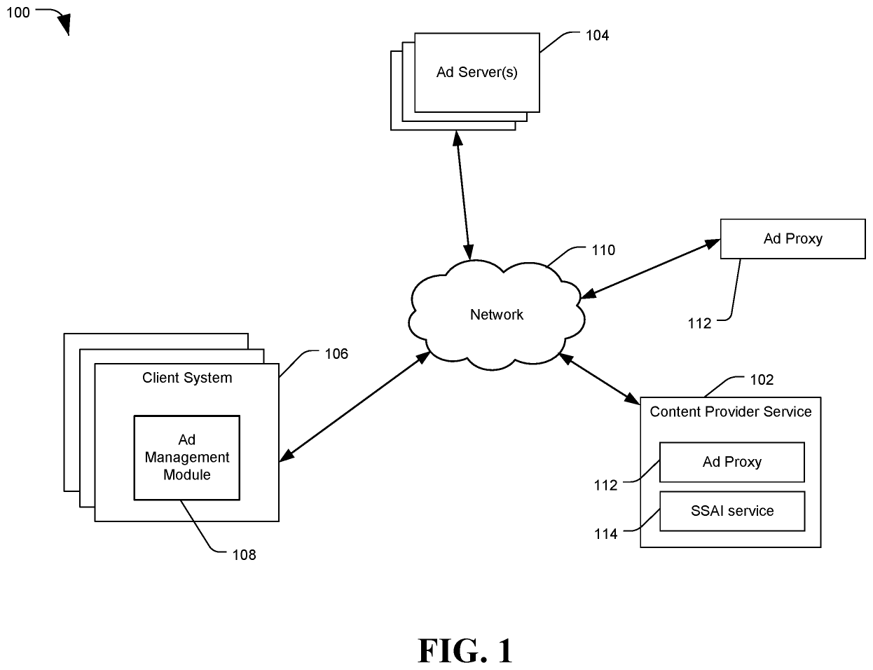

FIG. 1 depicts a diagram of a system 100 configured to implement a continuous ad proxy, in accordance with certain embodiments of the present disclosure. The system may include a streaming service or content provider service (CPS) 102, one or more ad servers 104, one or more client systems 106, an ad proxy 112, and one or more networks 110 over which the components of system 100 may communicate and exchange data. Each or any of CPS 102, ad server 104, client system 106, ad proxy 112, and network 110 may be implemented via computers, servers, hardware and software modules, or other system components. Elements of system 100 may also include or have access to one or more data storage devices, data storage mediums, data storage servers, and related data structures such as databases, which may store data files and related metadata, streaming content data, advertisements, resource libraries or executable code, or other information.

Client systems or client devices 106, such as computers, smartphones, set-top boxes, or televisions or other display devices, may be used to play media content, such as over-the-top (OTT) media streamed or broadcast over the internet, or video on demand (VOD) media. The media content may include video or audio content, and may be streamed (e.g., via an HTTP live-stream, HLS) or downloaded as a content file (e.g., an MP4 video file). Some media may be provided with advertising or advertising breaks. Advertising may be added to media content using server-side ad insertion (SSAI) or client-side ad insertion (CSAI).

SSAI may include inserting or “stitching” advertising directly into the media content at a remote server (e.g., content provider service 102), prior to providing the combined media and advertising to the client systems 106. SSAI may provide limited or prohibitively expensive or complex capability to tailor the advertising to particular clients, because combined media and advertising streams may be generated and provided to large groups of clients. Without generating a customized stream for every client system 106 at the media server. SSAI provides limited flexibility in adapting the advertising based on a variety of factors.

CSAI may operate by having the client system 106 make calls to an ad server 104 that responds with the ad, and the client system 106 can insert the received ads into ad breaks of media content. As CSAI may be handled by each individual client system 106, it may allow for more tailored or dynamic advertising. However, the complexity of managing the logic to determine how many ads to play, and which ads, from which ad provider, as well as other considerations, may limit the scalability of the CSAI approach. For example, the providers of client systems 106 may want to keep the devices as simple as possible to reduce costs and potential errors, and may want to avoid pushing software updates to client systems 106 that may interrupt a customer's ability to use the device.

As an example, client system 106 may include a connected TV (CTV) receiving media content over network 110 (such as the internet) from a content provider service 102. The client system 106 may be set up in a private location such as a home, or a public venue such as a bar, club, or store. Considerations that may be considered when selecting advertising may include a target number of ads per ad break (which may be a variable number such as 2.7, that may result in two ads 30% of the time and three ads 70% of the time), with a number of ads changing depending on the time of day or how busy the venue is expected to be. The type or content of ads may be selected based on a geographic location of the venue, what type of venue it is, what time of day it is, what content channel the client device 106 is set to, or a host of other potential factors. The client device 106 may have metadata for some of these factors stored locally. Another consideration may include avoiding using a same advertisement too frequently.

Further, advertisements may be provided from a plurality of ad servers 104. Advertisers may “bid” on an advertising slot in real time through the ad servers, but some ad servers may not be configured to bid against each other or be accessed in the same manner, and so a pattern of how and when to “offer” a bidding opportunity to different ad servers 104 may need to be considered. For example, there may be different ad servers 104 for digital out-of-home (DOOH) advertising and CTV/OOT advertising, with different advertisers or different bidding pool funding for each set. DOOH may be advertising intended to reach audiences when they are out in public, while CTV/OOT advertising may be designed to reach customers via internet media broadcasting. In the example of a CTV in a public venue, both advertising pools are appropriate, but the different ad servers may each need to be given separate opportunities to bid on advertising slots.

Because of the potential complexity in scaling up advertising flexibility and customization for client systems 106, it may be advantageous to position significant amounts of ad selection and gathering logic at a system remote from the client systems 106. Accordingly, an advertising proxy service or system 112 is provided. The ad proxy 112 may generate ad break metadata and perform the complex ad selection and negotiation process for each client system 106. Client devices 106 may include an ad management module 108 configured to access the ad proxy 112 (e.g., via a Restful application program interface, API) when an advertisement break is pending in a media content stream or file. The ad proxy 112 may report negotiated ads to the ad management module 108. The client system 106, via the ad management module 108, may then simply retrieve the selected advertisements from the appropriate ad servers 104 for display during the ad break in the media content.

The ad proxy 112 may be a stand-alone system or service, or it may be incorporated into or managed by a content provider service 102 that is also providing the media content to the client system 106. The ad proxy 112 may communicate with client system 106, content provider service 102, or ad server 104 via network 110. The ad proxy 112 may receive an indication from client 106 when content is being streamed at the client system, and may receive metadata about client system 106, or an associated customer or account, from client system 106, content provider service 102, other sources, or a combination thereof. Based on default configurations, the metadata, or both, the ad proxy 112 may be configured to make a determination about how many ads to prepare, what type of ads, and from what ad servers 104. The ad proxy 112 may continually populate an ad queue to maintain a minimum number of ads from which the client system 106 may retrieve a selected number of ads for an upcoming ad break. The number of ads retrieved or provided for an upcoming ad break may be specified by the client system 106, or selected by the ad proxy 112. In some examples, the minimum number of ads may be enough to fill two or more average length ad breaks. The ad proxy 112 may negotiate with ad servers 104 in a selected priority, and may obtain metadata for a selection of advertisements to play during the client system's ad break. The metadata may be provided in a data format such as VAST (video ad serving template), and may include addressing or access information that the client device 106 may use to retrieve the actual ad content (e.g., a video file), as well as information about proof of play tracking, creative or campaign identifiers associated with ads, or other related information. The metadata for the selected list of ads in the queue may be stored to a data structure of the ad proxy 112, such as to a Redis (remote dictionary server) data store. The client system 106 may then retrieve a list of ad metadata, and use it to download or retrieve the selected advertisements (e.g., from ad servers 104), and present the ads during the media content ad break. The client system 106 may note proof of play tracking events (e.g., a percentage of the ad that has been played as it is presented), and relay the proof to the ad servers 104, the ad proxy 112, or any other appropriate system or entity.

Although examples herein are provided for a client system 106 obtaining ad metadata from ad proxy 112 and performing CSAI, the disclosure herein is not limited thereto. A server-side ad insertion (SSAI) service 114 (e.g., located at content provider service 102) may act in place of the client system 106, obtaining ad metadata from the ad proxy 112 and performing SSAI, for example on an HLS content stream. On request for ad asset file segments by the client system 106, the SSAI service 114 may send proof of play tracking data on the client system's behalf. Accordingly, references herein to operations performed by client system 106 and equivalents may alternately be performed by SSAI service 114.

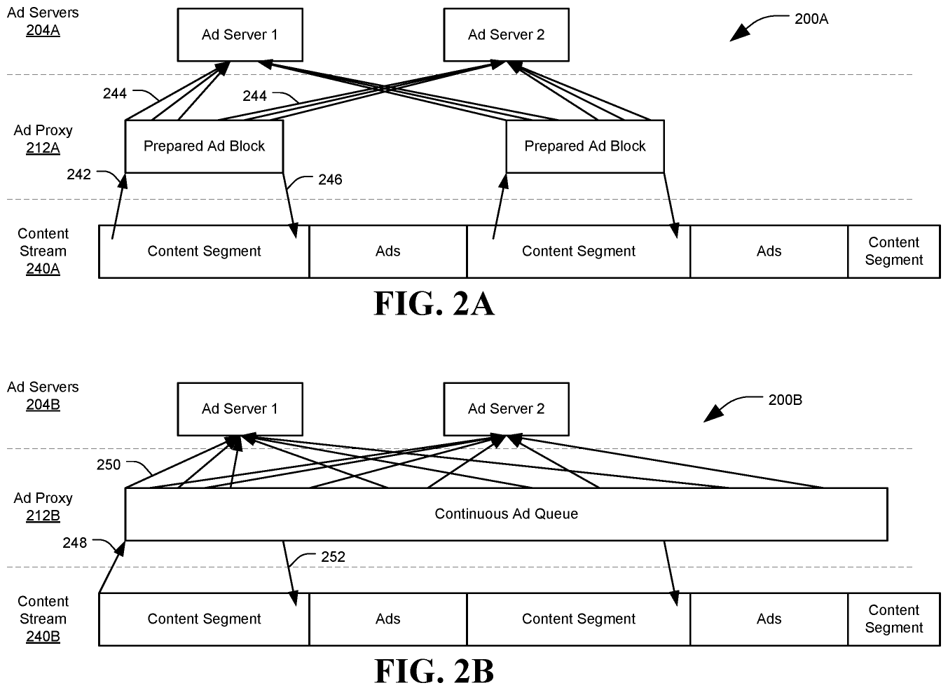

The ad servers 104 may include one or more systems through which advertisers can provide advertisements and bid on advertising opportunities or slots. For example, an ad server 104 may include a supply-side or sell-side platform (SSP) used to coordinate and manage the supply and distribution of ad inventories. An ad server 104 may also be a system or service to mediate for multiple SSPs, each of which may be affiliated with multiple advertisers, with different ad servers 104 managing SSPs for different advertising categories (e.g., DOOH, or CTV/OOT). An ad server 104 may also be configured to store and provide collections of “house” advertisements associated with a particular client system 106. For example, if client system 106 is a CTV set up at a bar, the bar may have its own advertisements for happy hour, live music events, or similar ads, which may be inserted in the ad breaks of the media content. Ad servers 104, such as for house ads, may be associated with or managed by content provider service 102, which may store metadata, ads, and client details for each client system 106, used in managing and customizing the media content provided to the client system. An example system and process for implementing a continuous ad proxy is described in further detail in regard to FIG. 2.

FIGS. 2A-2B depict diagrams of a system configured to implement a continuous ad proxy, in accordance with certain embodiments of the present disclosure. In particular, FIG. 2A depicts an embodiment 200A in which ads are loaded on a per-ad break basis. while FIG. 2B depicts an embodiment 200B in which ads are continuously added to a queue so that a minimum number or duration of ads are always available for use in ad breaks. The elements of FIG. 2A include reference numbers having an “A”, and elements of FIG. 2B include reference numbers having a “B”, although the basic reference numeral may be used when generally referring to elements in both figures. The embodiments depict sequences of operations and data transfers between a content stream 240 (e.g., via a client device 106), an ad proxy 212, and ad servers 204, which may correspond to client system 106, ad proxy 112, and ad server 104 of FIG. 1. Although not shown in FIGS. 2A, B, for the sake of clarity, information may also be exchanged between elements of system 200 and content provider service 102, or certain elements (such as ad proxy 212 or ad server 204) may be part of or managed by content provider service 102.

In system 200A, the ad proxy 212A may only prepare enough ads for an upcoming ad break in content stream 240A. Example embodiments of the implementation of system 200A are discussed in U.S. patent application Ser. No. 17/882,321, filed on Aug. 5, 2022, entitled “Ad Proxy Service”, the contents of which are included herein by reference. In system 200A, the content stream system 240A (e.g., at a client system 106) may send a notification 242 to an ad proxy 212A a selected time before an ad break begins. The notification 242 may indicate a number or length of ads to prepare for the ad break, and may also include metadata about the content stream system 240A, such as a geographic location and type of venue, and what content channel is selected, which may be used to select ads particular relevant to the content stream 240A. Based on the notification, the ad proxy 212A may negotiate 244 with one or more ad servers 204A to prepare an ad block to use during the upcoming ad break. The content stream system 240A may then retrieve 246 the prepared ad block from the ad proxy 212A before the ad break begins so the ads can be played. Although depicted as the content stream system 240A retrieving the prepared ad block from the ad proxy 212A, it should be noted that the prepared ad block may include metadata related to a selection of ads, and the content stream system 240A may use the metadata to retrieve the actual advertisements directly from the ad servers 204A. The process of notifying the ad proxy 212A of upcoming ad breaks, negotiating ads for the ad breaks between the proxy 212A and the ad servers 204A, and retrieving the prepared ads to play by the content stream system 240A may need to be repeated for every ad break. The timing of when the content server 240A must notify the ad proxy 212A to begin preparing an ad break may need to be carefully implemented, to enable the proxy to have sufficient time to negotiate the required ads for the break before the prepared ads are retrieved. Further, the ad proxy 212A may need to know just how long each ad break is, to prepare the specific number of length of advertisements.

System 200B provides an improved implementation for a continuous ad proxy, in accordance with certain embodiments of the present disclosure. In the embodiment of system 200B, the ad proxy 212B may continually keep an ad queue filled with a selected number, duration, variety, or other selection of advertisements. The ad proxy 212B may maintain an ad queue for each client device 106, The content stream system 240B may only need to retrieve ads for upcoming ad breaks, without the need to notify the ad proxy 212B of upcoming ad breaks as with prepare notification 242, or the ad proxy specifically selecting ads to fill a particular ad break within a limited time frame. The continuous ad proxy system 200B may involve a reduced number of network communications between the content stream system 240B and ad proxy 212B, and may involve lowered complexity and precision of implementation relative to system 200A.

Content stream system 240B may send an initial notification 248 to ad proxy 212B when a stream or channel is first started, to indicate when an ad queue should be filled. The notification may be sent from a client system 106 or content provider service 102. The notification may also include metadata about the client system 106 or content stream 240B (e.g., a type of venue, a geographic location, a product or service category, a target age range, type of content channel, etc.). The metadata may be used to select a targeted or customized ad selection, for client-side ad insertion (CSAI). In some embodiments, the ad proxy 212B may not need to receive a notification 248 to begin populating an ad queue, and may continually keep an ad queue populated, or may begin populating it based on other trigger, such as receiving a retrieval or fetch request 252. For example, each fetch request 252 may also include metadata about the client system 106 or content stream 240B, and the first fetch request 252 for a given content stream initiates the ad queue populating by the ad proxy 212B for that content stream.

The ad proxy 212B may populate the ad queue by negotiating 250 with one or more ad servers 204B. The ad proxy 212B may queue ads until it reaches one or more thresholds (such as always having selected duration of ads queued, a selected number of ads, a selected number of unique ads or ads from different sources, other thresholds, or a combination thereof).

At a selected time before an ad break begins, the content stream system 240B may retrieve 252 ads from the queue by issuing a fetch request. The retrieval 252 may include a negotiation process, in which information is exchanged between the content stream system 240B and the ad proxy 212B. For example, the content stream system 240B may retrieve a list of available ads and then retrieve ads that will fill the upcoming ad break. In another example, the content stream system 240B may notify the ad proxy 212B of the number of ads required or the length of the ad break, and the ad proxy 212B will select which ads to provide to the content stream system. For example, if the ad break is two and a half minutes, the ad proxy 212B may select two one minute ads and one thirty second ad. Certain ads may have a heightened preference or priority, such as more valuable ads (e.g., for which the ad provider will pay the streaming service more) or ads that were queued earlier and may “expire.” The ad proxy 212B may also perform deduplication or distribution so that the same ads are not played too close together. The ad queue may include metadata for negotiated ads, which may include information on how the content stream system 240B can access the actual video or audio advertisement from the ad servers 204B.

As discussed above, the first fetch request 252 for a given content stream 240B may serve as a content playing indicator to notify the ad proxy 212B that the content stream is playing and an ad queue should be filled. Accordingly, no ads may be available in the ad queue for the first ad break, or the fetch request 252 may be sent with enough time for the ad proxy 212B to negotiate 250 enough ads to fill the ad break and return those ads for content stream 240B, and thereafter negotiate additional ads to fill the ad queue.

The content stream system 240B may play the retrieved 252 ads during the ad break. In some embodiments, the content stream system 240B may provide ad tracking metadata to the ad proxy 212B, the ad servers 204B, or both, regarding which ads, and how much of each ad, were displayed during the ad break. Meanwhile, the ad proxy 212B may be aware of which ads were retrieved from the queue, and may negotiate additional ads from the ad servers 204B to maintain the queue thresholds. The ad proxy 212B may know which ads were played based on the ad playback metadata, based on which ads were selected during the ad retrieval 252, or by other means. The ad proxy 212B may continually keep the ad queue populated until it determines that further ads are not needed. For example, the ad proxy 212B may determine that it has stopped receiving ad reporting metadata or analytics, or stop receiving add retrievals 252, and conclude that the content stream 240B has been stopped or paused. Based on determining the content stream has stopped, the ad proxy 212B may empty to the ad queue, or keep it until a new or different content stream indicator is received (e.g., in case the channel is paused and new ad requests for the current ad queue are received after a long delay). In another example, the content stream system 240B may send an indicator when it is turned off or when the stream channel changes (e.g., based on a new stream start indicator 248 or a first fetch request 252 for a different content channel). If a content channel changes, it may involve changing which ads are appropriate for the channel, and accordingly the ad proxy 212B may dump or clear some or all adds from the queue, and may repopulate the queue with ads appropriate for the current content stream or channel 240B.

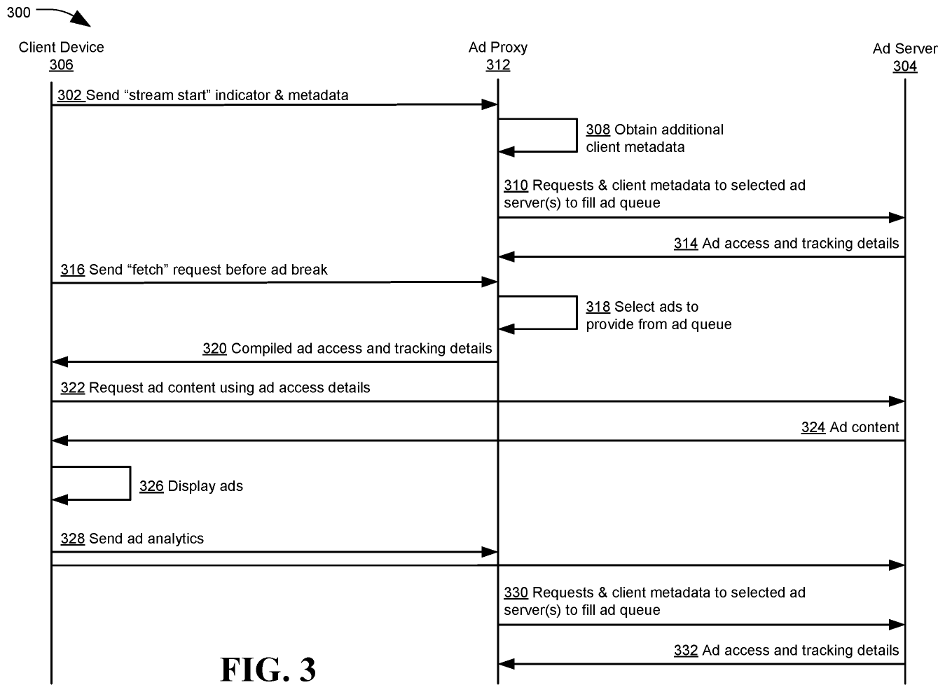

By maintaining a continuous ad proxy queue, system 200B may optimize ad fill rate and decouple the ad proxy 212B from needing to know exactly when and how long ad breaks are. Further, the continuous ad proxy may reduce the amount of communication messages within the system 200B. The operations of an example embodiment of system 200B is described in regard to FIG. 3.

FIG. 3 is a process flow diagram of a system 300 configured to implement a continuous ad proxy, in accordance with certain embodiments of the present disclosure. In particular, FIG. 3 depicts a sequence of operations and data transfers between a client device 306, an ad proxy 312, and an ad server 304, which may correspond to client system 106, ad proxy 112, and ad server 104 of FIG. 1. Although not shown in FIG. 3 for the sake of clarity, information may also be exchanged between elements of system 300 and content provider service 102, or certain elements (such as ad proxy 312 or ad server 304) may be part of or managed by content provider service 102.

At 302, client device 306 may send a “stream start” indicator and metadata to ad proxy 312, for example when a client device 306 is turned on or a new content channel is switched to. For example, client device 306 may begin showing a pre-downloaded VOD file, such as a 6-hour long MP4 file or a list of VOD segments comprising a 6-hour long loop, or may begin streaming content from one of various available streaming content channels. The “stream start” indicator may also include metadata about the client system 306 or an associated user or client, metadata about the content being displayed, or both. Metadata may include a device identifier (ID), addressing information, geographic location, venue type, time of data, media content channel or category being played, or other details which may be used by the ad server 312 to determine what type of ads to gather and negotiate them for the client system 306.

At 308, ad proxy 312 may obtain additional client metadata, for example from a database accessible by the ad proxy 312, from a content provider service 102 that maintains details regarding clients, or from other resources. For example, the client device 306 may not maintain details about a type of venue, a geographic location, or a category of content being shown, but such details may be available from content provider service 102.

At 310, the ad proxy 312 may issue requests or bidding opportunities to selected ad server(s) 304 to meet ad thresholds for the ad queue. As part of the request, the ad proxy 312 may provide certain client metadata to the ad server 304. For example, a client device 306 identifier may be provided, so that the ad server can recognize when the proper client device 306 attempts to access the negotiated ad, and authorize the access. For the ad requests or bidding opportunities, the ad proxy 312 may determine a threshold number or duration of ads to obtain to fill an ad queue, and may further determine what ad servers 304 to offer ad slots to, and in what priority. For example, the ad proxy 312 may be configured to queue fifteen minutes of advertisements, and may have settings regarding a permitted amount of duplication in the ads or ad providers, may seek to obtain a specific number or minimum amount of variety in advertisement lengths (e.g., to fill ad breaks of different durations), or other advertisement requirements. The ad slots may be filled based on which ad servers provide a successful bid during a prioritized bidding opportunity schedule. For example, the ad proxy 312 may be configured to offer ad slots to selected ad servers 304 in a selected order (e.g., cycling through in a same order round-robin style until the queue is filled), or may offer a first X number of consecutive bids to a first ad server, a second Y number of consecutive bids to a second ad server, and so on. Ad servers may allow advertisers to bid on ad slots in real time, and in some cases no valid bids will be received when an ad server 304 is polled. Accordingly, the ad server 312 may fill the ad queue based on whichever valid bids are received first, based on offers made to different ad servers 304 in a selected order. The ad proxy 312 may also allocate a maximum or minimum number of slots in the queue to “house” ads from the venue in which the client 306 is located. Bidding opportunities may be provided in any desired order to different ad servers 304, with the ad proxy 312 configured to end bidding opportunities when the queue thresholds have been met. The types of ads requested, the ad servers 304 the bidding opportunities are provided to, or other ad acquiring considerations may be based on metadata about the client device 306, the associated account or user, the content stream or video being displayed, or other factors.

At 314, the ad server 304 may respond to the ad request or bidding opportunity with details on a selected ad, including how to access the ad (e.g., a network address and potentially access credentials), advertising campaign information, play tracking details, or other information. For example, proof of play tracking information may be reported by a client device 306 when 25%, 50%, 75%, and 100% of an ad has played, for purposes of payment for the ad being fully displayed. The received ad details or metadata may be stored by the ad proxy 312 to the ad queue.

At 316, the client device 306 may issue a “fetch” request to the ad proxy 312 at a time period before an ad break. The fetch request may include an indicator of an ad break duration (e.g., a specific length, or an indication that there is no specific length), a desired number of ads, or other information. The “fetch” request may be issued early enough before the ad break to allow the client device 306 time to download or retrieve the actual content of the ads (e.g., a video file). For the client device 306 to know when to issue the fetch request, the content stream or video may provide indicators or identifiers regarding ad breaks. For example, a VOD file may be accompanied by metadata indicating where ad breaks should be inserted during play, or indications on when the client device 306 should issue “fetch” notifications to prepare for an ad break. Indications on when or where to insert an ad may also be embedded within a video file itself, or as SCTE-35 markers in an HLS stream. The client system 306 may also download or receive a configuration file (e.g., from content provider service 102), which may define when ad breaks will occur, or when to issue fetch requests, for each channel or video file of content.

At 318, the ad proxy 312 may respond to the fetch request by selecting a list of ads to provide from the ad queue. The ad proxy 312 may select ads based on factors such as the value of playing the ad, an age of the ad (e.g., how long ago it was added to the queue), a length of the ad break, deduplication of or time since same or similar ads have been displayed, or other factors. The ad proxy 312 can also adjust an ad load for the client device 306 over time. For example, the ad proxy 312 may be configured with a rule for ads in the response 318 that limits the ad load to a rolling fourteen minutes of ads per hour. The ad proxy 212 may implement this by storing ad play times for the client device 106 over the last 60 minutes, and only return ads such that the ad load is still approximately or equal to fourteen mins per hour. The compiled ad list may include access and tracking details for each ad. The ad proxy 312 may store ad information to a queue, such as a data structure (e.g., as a Redis cache), as each ad is negotiated or identified with the ad server 304. At 320, the ad proxy 312 may then provide a list identifying the ads to the client system 306, along with potential security or credential information, playback tracking and analytics information, or other associated metadata.

At 322, based on the ad access information received from the ad proxy 312, the client device 306 may request the ad content from one or more ad servers 304. For example, the client device 306 may use a network address or link to access a video file for an advertisement, and may provide a device ID for the client device 306, or other authentication information (e.g., a security key, pin, password, or other credentials), to verify that the client device 306 is accessing the advertisement negotiated between the ad proxy 312 and the ad server 304.

At 324, the ad server 304 may provide the ad content to the client device 306. At 326, the client device 306 may play the ads once the ad break has been reached. For example, at a specified ad break time, the client device 306 may pause the media content file or stream, and play the ads negotiated by the ad proxy 312 and obtained from the ad servers 304. Once the ads have finished playing, the client device 306 may resume the media content file or stream.

At 328, the client device 306 may send ad analytics during or after playback of the ads. The ad analytics may include proof of playback information, any client engagement at the client device if appropriate, or other analytics information. The analytics information may be sent to the ad proxy 312, the ad server 304, the content provider service 102, or any combination thereof. For example, the various parties involved in the negotiation and payment for advertising may all wish to receive playback evidence for settling any advertising payments.

At 330, the ad proxy 312 may issue additional requests or bidding opportunities to selected ad server(s) 304 to once again meet the ad thresholds for the ad queue. This may be performed at any time ads have been “removed” or “consumed” from the ad queue, bringing the queue below the selected threshold(s). For example, ads may “time out” or “expire” if not played within a selected period of time, resulting in the ads being deleted or removed from the queue. In some embodiments, the ad proxy responding to a “fetch” request at 318 may be considered to “consume” the selected ads. In another example, the ad proxy 312 receiving a 100% playback analytics response for an ad at 328 may be considered “consuming” the ad, as failure to play the entire ad may mean the ad can still be played later. In response to the additional ad requests or bidding opportunities of 330, the ad server 304 may provide ad access and tracking details for further ads, at 332, which may bring the ad queue up to the desired threshold. If not, the ad proxy 312 may issue additional ad requests, at 330, until the ad queue has been refilled.

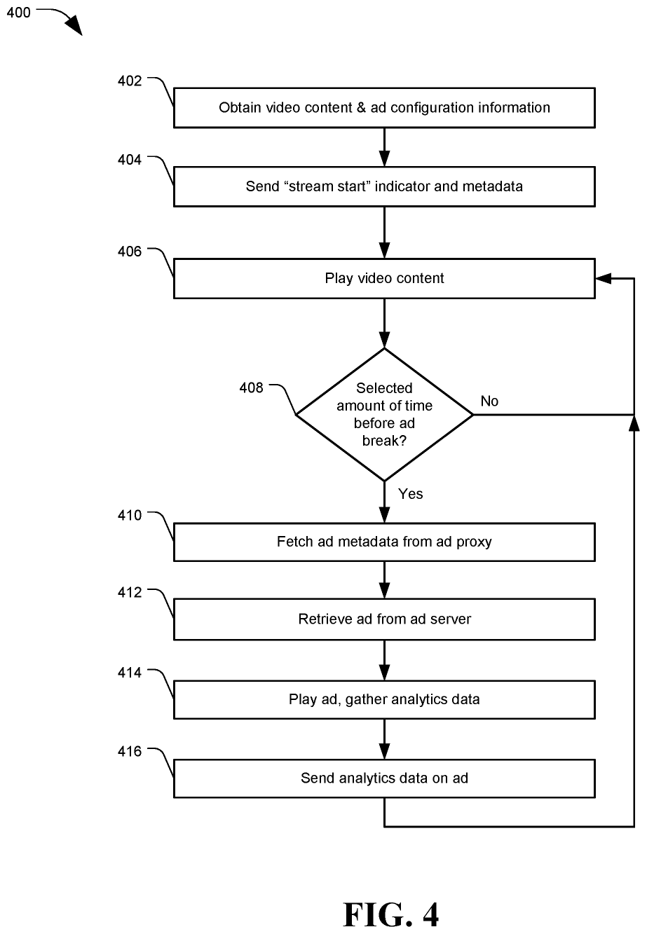

Turning now to FIG. 4, a flowchart 400 of an example method for implementing a continuous ad proxy is shown, in accordance with certain embodiments of the present disclosure. In particular, FIG. 4 may depict an example method for requesting, receiving, and reporting ad content at a client device. The method may be implemented by a client system, such as client system 106 of FIG. 1 or client device 306 of FIG. 3.

The method may include obtaining video content and ad configuration information, at 402. The video content may include a video on demand (VOD) downloaded file (e.g., an MP4 video file), an HTTP livestream (HLS) video feed or other over the top (OTT) content, or other audio or video content. In some examples, multiple pieces of video content may be obtained, such as different video content for each channel of a plurality of OTT channels. Ad configuration information may be instructions or code directing the client system to implement ad breaks at certain points in the video content, at certain time intervals, or at other points. The ad configuration information may direct the client system to contact a specified ad proxy server when initiating a content stream or display and at specified or selected times prior to an ad break, for issuing fetch requests from the client system to the ad proxy. In some examples, the client system may be pre-configured to access a specified ad proxy, or the ad proxy information may be set in system configuration or other settings files. The ad configuration information may also provide instructions on how the client system should convert or play ad files, report proof of play information, or otherwise handle ad content. Both the video content and ad configuration information may be obtained from the same source (e.g., a content provider service 102), or may be obtained from different sources (e.g., the video content from content provider service 102 and the ad configuration information from ad proxy 112).

At 404, the method may include sending a “stream start” indicator and metadata from the client system to the ad proxy. The “stream start” indicator may notify the ad proxy that the client system has started a content stream or display (including switching to a new content channel), and that the ad proxy should begin filling an ad queue of relevant advertisements. The metadata may include metadata about the client device or the content stream or channel, as described herein. The metadata may enable the ad proxy to negotiate with ad servers on behalf of the client device, and to select customized advertising relevant to the client device, the content channel, or both. In some embodiments, the method may not include sending a separate stream start indicator, and may instead notify an ad proxy of a current content channel being played through fetch requests, at 410.

At 406, the method may include playing the video content. The video content file or stream may be displayed on a screen or monitor of the client system, or connected to the client system. The client system may continue playing the video content until the ad break is reached, including during following steps of determining and sending fetch requests and retrieving ad content.

A determination may be made whether a selected amount of time before a scheduled ad break has been reached, at 408. For example, the ad configuration information may indicate that an ad break is scheduled at the ten minute mark of the video content, and that an ad fetch request should be issued two minutes earlier, or at the eight minute mark. The selected amount of time at which to send a fetch request may also be part of configuration data or settings of the client device. The selected amount of time may be configured to allow the client device sufficient time to retrieve a list of ads from an ad proxy and to retrieve the ad content from an ad server. If the selected amount of time before the ad break has not been reached, the method may include continuing to play the video content, at 406.

When the selected amount of time before the ad break has been reached, the method may include issuing a fetch request to the ad proxy, or otherwise retrieving ad content from the ad proxy, at 410. The fetch request may optionally include metadata about the current content channel being played, and may function as a “stream start” indicator in some embodiments. In some examples, the fetch request may specify an ad break duration or a requested number of ads, to indicate to the ad proxy how many or what ads to return metadata for. For example, the client system may send the ad proxy a fetch request, and the ad proxy may respond by sending one or more files identifying a selection of one or more ads. In another example, the ad proxy may store the ad information to a memory location accessible by the client system, so that the client system can directly retrieve the ad information from the memory. The ad metadata may include a list of the ads or digital signage to display, information on how to access or retrieve the actual ad content (e.g., a network address for a video file), information on creative and campaign IDs that may be tied to the ads, proof of play tracking information, or other details. The ad metadata may be provided by the ad proxy to the client system in a standardized format recognized by the client system, even if individual ad servers provide ad results to the ad proxy in different formats. In some examples, the ad proxy may provide the actual ad content (e.g., video, images, audio) for some or all of the ads in addition to ad metadata.

At 412, the method may include retrieving the ad content from an ad server. While the ad proxy may provide actual ad content or assets directly to the client system, in other instances the client system may use the ad metadata from the ad proxy to locate and retrieve ad content from an ad server. For example, the ad proxy may use the client system ID when negotiating an ad, and then provide the client system with a network link to the ad assets. The client system may provide its client system ID via the network link to verify its identity and receive authorization to obtain the advertisement assets.

The method may include playing the one or more retrieved ads, at 414. The ads may be played or displayed during a scheduled ad break, or may be played or displayed immediately upon receipt. If the ad is played during a scheduled ad break, the client system may download or cache the ad locally, and wait until the ad break is reached before playing the ad. In some examples, the ad may be streamed live during the ad break, rather than downloaded. If multiple ads are to be played during the ad break, a first ad may be played while a second or subsequent ad are still being downloaded or accessed. While playing the ad, the client system may track proof of play information or other analytics data. For example, some advertisements may enable customer feedback or interaction, and the system may monitor whether any interaction is detected. Analytics information may also include what time the ads were displayed, how often, or other information. For example, the client system may cache or store ads, and may play them during multiple ad breaks as part of the negotiated advertising arrangement negotiated by the ad proxy.

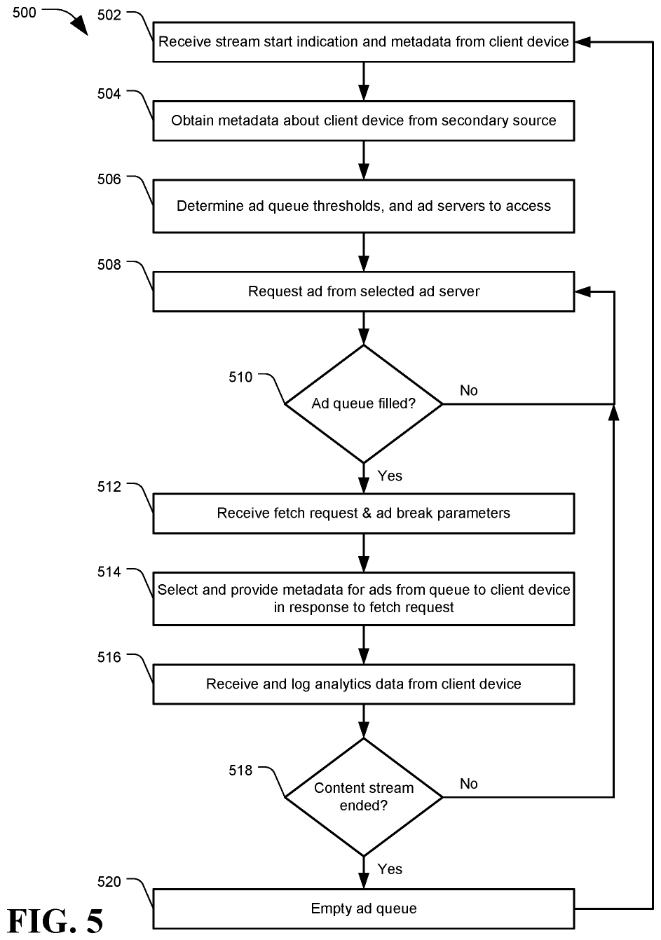

At 416, the method may include sending analytics data on the ads that have been played. Analytics data may be sent to one or more entities or systems, including an ad server, ad proxy, content provider service, another recipient, or any combination thereof. Analytics data may be sent during the ad playback (e.g., to provide updates on what percentage of the ad has been played), or after the ad (either immediately upon completion of the ad, or at a later point, such as once the ad has been played a selected number of times). The method may then return to 406, and resume playing the video content once the ad break has concluded, and monitoring for when to send a fetch request for a next ad break. Another example method of implementing a continuous ad proxy, from the perspective of the ad proxy system, is described in regard to FIG. 5.

FIG. 5 depicts a flowchart 500 of an example method for implementing a continuous ad proxy, in accordance with certain embodiments of the present disclosure. In particular, FIG. 5 may depict an example method for negotiating and preparing one or more ads for display at a client system. The method may be implemented by a continuous ad proxy system, such as ad proxy 112 of FIG. 1 or 212 of FIG. 2.

The method may include receiving a stream start or other content playing indication and metadata from a client device, at 502. The stream start indication and metadata may correspond to those discussed in regard to element 302 of FIG. 3. In some examples, the stream start indication may include a “fetch” request for ad metadata for an upcoming ad break. Based on identifying information for the client device, the method may also include obtaining additional metadata about the client device from a secondary source, at 504. For example, the client device or its associated customer may have an account with a content provider service (such as content provider service 102 of FIG. 1), and the method may include accessing details about the client device or customer from that source. Client preferences, viewing history, or other information may be available from the secondary source that are not available from the client device directly. The metadata from the client device and secondary sources may be used in selecting appropriate advertisements.

At 506, the method may include determining ad queue thresholds (such as a minimum number of ads or a minimum total ad duration), and ad servers to access or negotiate with to ensure ads are continuously available for retrieval by the client system. As discussed herein, the ad queue thresholds may also include requirements on a variety of ad durations, a variety of different types of ads, a variety of ads from different ad servers or ad providers, or other requirements. The selection of ad servers, or the types of ads to request or accept bits on, may be based on metadata associated with the client device, such as a type of venue, an age range of viewers, a geographic location, or other factors.

Which ad servers to access, and in what order, may be part of a mediation process implemented by the ad proxy. For example, different types of ad servers may be given an opportunity to bid on ad slots, but must be offered the opportunities separately (e.g., if different types of ad servers are not configured to bid against each other) and one-at-a-time (e.g., to avoid simultaneous bids on a single slot). Accordingly, the ad proxy may determine how many bidding opportunities to provide to which ad servers, and in which order. Further, based on client factors such as content preference, venue type, customer age range, video content channel or type, or other factors, certain ad categories or servers may be more appropriate than others. Accordingly, the ad proxy may use client metadata, preconfigured ad server priorities, or other factors to generate an order or priority in which to access one or more ad servers, until the ad queue thresholds have been reached. As explained above, bidding on ad slots may be performed in real time, and providing a bidding opportunity to an ad server may not result in any accepted bids on any given access, but may result in a valid bid on a next access. Therefore, the access priorities may include offering ad server 1 three consecutive bidding opportunities, followed by providing ad server 2 five consecutive bidding opportunities. Additional options, such as selecting a house ad for the client venue for every set amount of third-party ads, may also be factored into the ad server's process. In another example, a house ad may be included in a list of ads returned every time a client device fetch request is received, without the house ads counting against the ad queue thresholds. Once the ad servers to access and the access order have been determined, the method may include requesting or offering bidding opportunities to the selected ad servers, at 508. Metadata for ads from the ad servers may be stored to a queue data structure or list. The ad metadata may correspond to the metadata discussed in regard to element 314 of FIG. 3.

At 510, a determination may be made whether the ad queue thresholds have been reached, such as determining if the queue has been filled with ads to a minimum requirement. If not, the method may include continuing to request ads or provide bidding opportunities to the selected ad servers, at 508.

At 512, the method may include receiving an ad break indicator or fetch request and ad break parameters from a client device. The fetch request may be an indication that the ad proxy should return a list of ad metadata for an upcoming ad break. The ad break parameters may indicate a duration or number of ads needed for the ad break, or merely an indication that an ad break is approaching. In some examples, the ad break indicator may be received as part of the “stream start” indicator of 502, and the method may not include receiving as separate fetch request at 512.

In response to the fetch request (e.g., at 502 or 512), the method may include selecting and providing metadata for ads from the ad queue to the client device, at 514. The ad proxy may select ads to fill the ad break according to the ad break parameters, such as filling an ad break duration or ad number. If no number of ads was specified by the client system, the ad proxy may determine a number of ads to return, such as based on a setting of 2.7 ads (e.g., with a 30% chance of two ads and a 70% chance of three ads), or a target ad load for a time period (e.g., number of advertisements per hour). Ads may also be selected based on factors such as an age or expiration of ads from the queue, a value of playing different ads, or other factors. Metadata for the selected ads may be compiled or added to a data structure or list and returned to the client device. The metadata may be used by the client device to access the corresponding ad content from ad servers. In some embodiments, the ad proxy may provide the ad content directly to the client system.

At 516, the method may include receiving and logging analytics data from the client device. The analytics data may be used to verify that the ads that were negotiated were the same ones that were played by the client device, how much of each ad was played, or any other feedback. The analytics data may be used to ensure that proper payment is exchanged between the ad server (or ad creator) and the ad proxy, content provider service, or client associated with the client device.

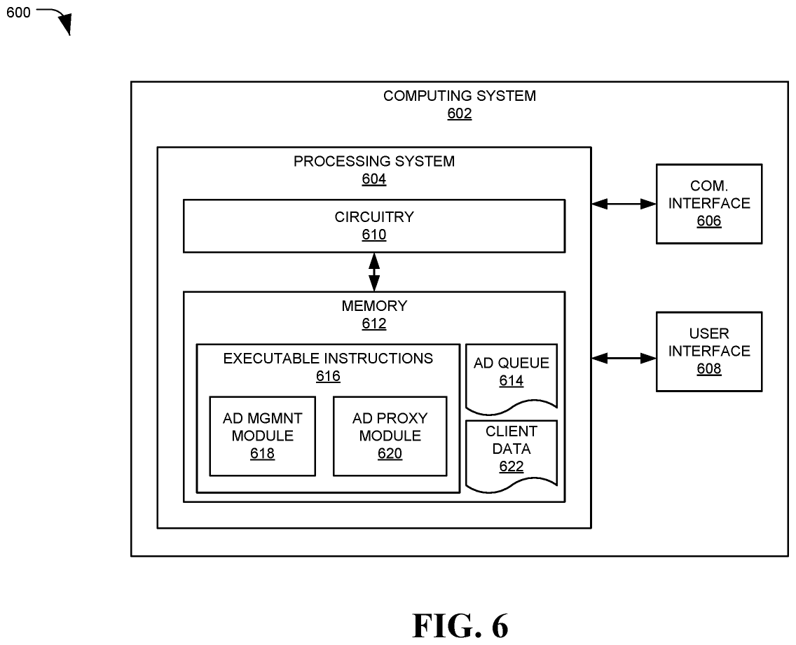

At 518, the method may include determining if the content stream has ended. The stream ended check may be performed at other or additional points in the method, such as before receiving a fetch request at 512. The content stream may be determined to have ended if no fetch request has been received for a selected period of time, if a “stream end” indicator has been received, if a “stream start” indicator or fetch request for a new content channel has been received, or based on other factors. If the content stream has not ended, the method may include continuing to request ads to keep the ad queue filled, at 508. If the content stream is determined to have ended, the method may include emptying the ad queue, at 520. For example, if all content streaming for a client device has ended, the queue may be emptied entirely. If the current content stream has ended based on changing to a different content channel (for which different advertisements may be appropriate), the method may include emptying the queue for the current channel and populating a queue for the new content channel. Accordingly, the method may then include receiving a stream start indicator at 502 and proceeding to populate an ad queue as described above. An example computing system for implementing an ad proxy system is described in regard to FIG. 6.

FIG. 6 is a diagram of a system 600 configured to implement a continuous ad proxy, in accordance with certain embodiments of the present disclosure. In particular, FIG. 6 depicts a computer system 602, which may be an example of any computing system that may be employed to perform the operations of content provider service 102, ad server 104. client system 106 or ad management module 108, ad proxy 112, SSAI service 114, and related processes and methods. Computing system 602 may include a processing system 604, a communication interface 606, and a user interface 608. Computing system 602 may include other components, such as a battery and enclosure, that are not shown for clarity. Computing system 602 may comprise one or more server computing systems, desktop computing systems, laptop computing systems, smartphone devices, set-top or streaming boxes, connected televisions, or any other computing system, including combinations thereof.

Communication interface 606 may comprise components that communicate over communication links, such as network cards, ports, radio frequency (RF), processing circuitry and software, or other communication components. Communication interface 606 may be configured to communicate over metallic, wireless, or optical links. Communication interface 606 may be configured to use Time Division Multiplex (TDM), Internet Protocol (IP), Ethernet, optical networking, wireless protocols, communication signaling, other communication formats, or any combinations thereof. In particular, communication interface 606 may be configured to communicate over a network 110 with content provider service 102, client systems 106, ad servers 104, ad proxy 112, or other external systems. Communication interface 606 may also enable communication with local external devices, such as external storage or interface devices.

User interface 608 may comprise components that interact with a user to receive user inputs and to present media or other information. User interface 608 may include a display screen, touch screen, touch pad, keyboard, buttons, speaker, microphone, pointer device or interface, communication port, other user input/output apparatus, or any combination thereof. In some examples, user interface 608 may be a module configured to interface with a separate system for presenting information and receiving inputs. For example, computing system 602 may have limited or no direct user input components, but it connects (e.g., via communication interface 606) to a monitor or other device that may receive inputs via touch screen, remote control, or other input method, which inputs are then provided or relayed to computing system 602.

Processing system 604 may be linked to communication interface 606 and user interface 608. Processing system 604 can include processing circuitry 610 and memory device 612. Memory device 612 can store executable instructions or other operating software 616, as well as non-executable data files, such as an ad queue 614, and client data 622.

Processing circuitry 610 may comprise a microprocessor and other circuitry that can retrieve and execute instructions 616 from memory device 612. Memory 612 may comprise a non-volatile data storage medium, such as a disk drive or solid state drive, or volatile memory such as random access memories (RAM) and dynamic RAM (DRAM), or any other memory apparatus. In some examples, processing circuitry 610 may be mounted on a circuit board that may also hold memory device 612 and portions of communication interface 606 or user interface 608.

Executable instructions 616 may comprise computer programs, firmware, or some other form of machine-readable processing instructions. Executable instructions 616 may include ad management module 618, and ad proxy module 620, although related operations may be handled by multiple different modules or programs (potentially located on multiple computing devices), all operations may be performed by a single module, or additional modules may be included in executable instructions 616. For example, embodiments of ad management module 618 and ad proxy module 620 may be implemented by content provider service 102, client system 106 or ad management module 108, ad server 104, ad proxy 112, other systems, or a combination thereof. Executable instructions 616 may further include an operating system, utilities, drivers, network interfaces, applications, or other types of software. When executed by processing circuitry 610, executable instructions 616 may direct processing system 604 to operate computing system 602 as described herein.

Ad management module 618 may be a set of instructions for preparing for or executing ad breaks for a client system 106. An ad management module 618 located at a client system 106 may be configured to obtain ad configuration information (e.g., from content provider service 102, or as metadata of a video file), send stream start indicators and metadata, determine timing for sending fetch requests to an ad server 112, obtaining ad assets, presenting advertisements at an ad break of a media content video or stream, and monitoring and reporting analytics data for an ad. At other systems, such as a content provider service 102, ad server 104, or ad proxy 112, an ad management module 618 may generate or provide ad configuration information to a client system 106, transmit ad content or metadata, or otherwise manage the preparation or play of ads at a client system 106.

Ad proxy module 620 may include a set of computer functions, instructions, or access details for performing continuous ad proxy services or operations. For example, ad proxy module 620 may be configured to negotiate with ad servers 104 for advertisements to present at a client system 106, including adding ad metadata to an ad queue data structure 614. The ad proxy module 620 may obtain client data or metadata 622 from client system 106, content provider service 102, or other sources. Further, the ad proxy module 620 may determine ad queue thresholds (e.g., a number of ads or a minimum ad duration of all ads in the queue, a distribution of different ads, etc.), a selection of relevant ads and ad servers, ad server access or bidding order, and content or types of ads to negotiate for, for example based on client preferences or data 622. The ad proxy module 620 may select a list of ads to provide to a client system in response to a fetch request, and may be configured to keep the ad queue populated according to the minimum thresholds.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the above embodiments, and other embodiments not specifically described herein, will be apparent to those of skill in the art upon reviewing the description. Steps depicted in the flowcharts may optionally be excluded, added, performed in a different order, or performed with different degrees of concurrency than shown (e.g., steps depicted as sequential may be performed concurrently). Additionally, the illustrations are merely representational and may not be drawn to scale. Certain proportions within the illustrations may be exaggerated, while other proportions may be reduced. Accordingly, the disclosure and the figures are to be regarded as illustrative and not restrictive.

1. A method comprising:
performing an ad proxy service at an ad proxy server, including:
receiving a content playing indicator from a client device indicating that the client device is playing content;
in response to the content playing indicator, negotiating a plurality of advertisements with an ad server by obtaining ad metadata to fill an ad queue of the ad proxy service;
receiving an ad break indicator from the client device requesting ad metadata for an upcoming ad break in content playing at the client device;
providing the client device with first ad metadata corresponding to a subset of the plurality of advertisements selected from the ad queue to fill the ad break; and
automatically refilling the ad queue as advertisements are consumed.

2. The method of claim 1 further comprising:
receiving an ad break parameter from the client device; and
selecting the subset of the plurality of advertisements based on the ad break parameter.

3. The method of claim 2 further comprising:
the ad break parameter includes a time length of the ad break; and
selecting the subset of the plurality of advertisements includes selecting advertisements having durations that add up to the time length.

4. The method of claim 2 further comprising:
the ad break parameter includes a number of requested ads for the ad break; and
selecting the subset of the plurality of advertisements includes selecting the number of requested ads from the ad queue.

5. The method of claim 1 further comprising:
filling the ad queue includes negotiating sufficient advertisements to meet a selected threshold, wherein the selected threshold includes a total duration of advertisements.

6. The method of claim 1 further comprising:
filling the ad queue includes negotiating sufficient advertisements to meet a selected threshold, wherein the selected threshold includes a total number of advertisements.

7. The method of claim 1 further comprising:
obtaining metadata corresponding to the client device; and
negotiating the plurality of advertisements to correspond to the metadata.

8. The method of claim 7 further comprising:
selecting the ad server, from a plurality of ad servers, to negotiate the advertisement with based on the metadata.

9. The method of claim 1 further comprising:
receiving analytics data from the client device regarding playback of the subset of the plurality of advertisements; and
determining the subset of the plurality of advertisements is consumed based on the analytics data.

10. The method of claim 1 further comprising:
determining the subset of the plurality of advertisements is consumed based on providing the client device with the first ad metadata.

11. A system comprising:
an ad proxy server configured to perform an ad proxy service, including:
receive a stream start indicator from a client device indicating that the client device has begun playing a content stream;
in response to the stream start indicator, negotiate a plurality of advertisements with an ad server by obtaining ad metadata to fill an ad queue of the ad proxy service;
provide the client device with first ad metadata corresponding to a subset of the plurality of advertisements selected from the ad queue to fill an ad break of the client device; and
automatically refill the ad queue as advertisements are consumed.

12. The system of claim 11 comprising the ad proxy server further configured to:
receive an ad break parameter from the client device, the ad break parameter including a time length of the ad break; and
select the subset of the plurality of advertisements based on the ad break parameter, including selecting advertisements having durations that add up to the time length.

13. The system of claim 11 comprising the ad proxy server further configured to:
receive an ad break parameter from the client device, the ad break parameter including a number of requested ads for the ad break; and
select the subset of the plurality of advertisements based on the ad break parameter, including selecting the number of requested ads from the ad queue.

14. The system of claim 11 further comprising filling the ad queue includes negotiating sufficient advertisements to meet a selected threshold, wherein the selected threshold includes a total duration of advertisements.

15. The system of claim 11 further comprising filling the ad queue includes negotiating sufficient advertisements to meet a selected threshold, wherein the selected threshold includes a total number of advertisements.

16. The system of claim 11 comprising the ad proxy server further configured to:
obtain metadata corresponding to the client device; and
select the ad server, from a plurality of ad servers, to negotiate the advertisement with based on the metadata.

17. A memory device storing instructions that, when executed, cause a processor to perform a method comprising:
obtaining, at a client device from an ad proxy service, advertisements for display during ad breaks in content playing at the client device, including:
sending a content playing indicator to the ad proxy service indicating that the client device has begun playing content;
prior to each ad break, sending a fetch request to the ad proxy service directing the ad proxy service to provide ad metadata corresponding to an advertisement for the upcoming ad break to the client device;
obtaining the advertisement from an ad server based on the ad metadata; and
displaying the advertisement during the upcoming ad break.

18. The memory device of claim 17 storing instructions that, when executed, cause the processor to perform the method further comprising:
sending an indication of a duration of the upcoming ad break along with the fetch request; and
receiving, from the ad proxy service, the ad metadata corresponding to a plurality of advertisements having a total time equal to the duration.

19. The memory device of claim 17 storing instructions that, when executed, cause the processor to perform the method further comprising:
sending an indication of a requested number of advertisements for the upcoming ad break along with the fetch request; and
receiving, from the ad proxy service, the ad metadata corresponding to the requested number of advertisements.

20. The memory device of claim 17 storing instructions that, when executed, cause the processor to perform the method further comprising:
obtaining analytics data indicating completion of display of the advertisement during the ad break; and
transmitting the analytics data to notify the ad proxy service that the advertisement has been consumed.
